(19) United States
(12) Patent Application Publication
(10) Pub. No.: US 2008/0199701 A1
(43) Pub. Date: Aug. 21, 2008

(54) Encapsulated nanoparticles for the absorption of electromagnetic energy

(76) Inventors: Manfred R. Kuehnle, Lincoln, MA (US); Hermann Statz, Wayland, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/437,184

(22) Filed: May 19, 2006

Related U.S. Application Data
(63) Continuation-in-part of application No. 10/780,901, filed on Feb. 18, 2004, now abandoned.
Application No. 10/780,901 is a continuation-in-part of application No. 10/780,896, filed on Feb. 18, 2004, now abandoned.
(60) Provisional application No. 60/450,131, filed on Feb. 25, 2003.
(60) Provisional application No. 60/449,887, filed on Feb. 25, 2003.
(60) Provisional application No. 60/449,887, filed on Feb. 25, 2003.
(60) Provisional application No. 60/450,131, filed on Feb. 25, 2003.

(51) Int. Cl. B32B 1/00; B32B 9/00

(52) U.S. Cl. 428/403; 428/404

(57) ABSTRACT

Composite materials that can be used to block radiation of a selected wavelength range or provide highly pure colors are disclosed. The materials include dispersions of particles that exhibit optical resonance behavior, resulting in the radiation absorption cross-sections that substantially exceed the particles' geometric cross-sections. The particles are preferably manufactured as uniform nanosize encapsulated spheres, and dispersed evenly within a carrier material. Either the inner core or the outer shell of the particles comprises a conducting material exhibiting plasmon (Froehlich) resonance in a desired spectral band. The large absorption cross-sections ensure that a relatively small volume of particles will render the composite material fully opaque (or nearly so) to incident radiation of the resonance wavelength, blocking harmful radiation or producing highly pure colors. The materials of the present invention can be used in manufacturing ink, paints, lotions, gels, films, textiles and other solids having desired color properties. The materials of the present invention can be used in systems consisting of reflecting substances such as paper or transparent support such as plastic or glass films. The particles can be further embedded in transparent plastic or glass beads to ensure a minimal distance between the particles.

### RELATED APPLICATIONS

This application is a continuation-in-part of U.S. patent applications Ser. Nos. 10/780,901 and 10/780,896, both filed on Feb. 18, 2004, which claims the benefit of U.S. Provisional Application No. 60/450,131, filed on Feb. 25, 2003, and U.S. Provisional Application 60/449,887, also filed on Feb. 25, 2003. The entire teachings of the above application are incorporated herein by reference.

### BACKGROUND OF THE INVENTION

The present invention relates to the selective absorption of electromagnetic radiation by small particles, and more particularly to solid and liquid composite materials that absorb strongly within a chosen, predetermined portion of the electromagnetic spectrum while remaining substantially transparent outside this region.

Transparent and translucent materials such as glass, plastic, gels, and viscous lotions have for many years been combined with coloring agents to alter their optical transmission properties. Agents such as dyes and pigments absorb radiation within a characteristic spectral region and confer this property on materials in which they are dissolved or dispersed. Selection of the proper absorptive agent facilitates production of a composite material that blocks transmission of undesirable light frequencies.

Beer bottles, for example, contain additives that impart a green or brown color to protect their contents from decomposition. These include iron (II) and iron (III) oxides in the case of glass bottles, while any of a variety of dyes can be employed in plastic containers. The concentration of these additives (in weight percent relative to the surrounding carrier material) is generally very heavy, in the range of 1-5%. This results in high expense dispersion within the carrier, and the need to employ special mixing techniques to counter strong agglomeration tendencies.

Applied colorants such as paints and inks are used to impart a desired appearance to various media, and are prepared by dissolving or dispersing pigments or dyes in a suitable carrier. These materials also tend to require high pigment or dye concentrations, and are vulnerable to degradation from prolonged exposure to intense radiation, such as sunlight. The limited absorption and non-uniform particle morphology of conventional pigments tends to limit color purity even in the absence of degradation.

Most commercially useful coloring agents absorb across a range of frequencies; their spectra typically feature steady decrease from a peak wavelength of maximum absorption, or λₘₐₓ. When mixed into a host carrier, such materials tend to produce fairly dark composite media with limited overall transmission properties, since the absorption cannot be “tuned” precisely to the undesirable frequencies. If used as a container, for example, such media provides relatively poor visibility of the contents to an observer.

Traditional means of forming particles that may serve as coloring agents frequently fail to reliably maintain uniform particle size due to agglomeration, and cause sedimentation during and/or after the particles are generated. The problem of agglomeration becomes particularly acute at very small particle diameters, where the ratio of surface area to volume becomes very large and adhesion forces favor agglomeration as a mechanism of energy reduction. While suitable for conventional uses, in which radiation absorption is imprecise and largely unrelated to particle size or morphology, non-uniform particles cannot be employed in more sophisticated applications where size has a direct impact on performance.

Certain radiation-absorption properties of select conducting materials, known as Froehlich or plasmon resonance, can be exploited to produce highly advantageous optical properties in uniform, spherical, nanosize particles. See, for example, U.S. Pat. No. 5,756,197. These particles, we showed, may be used as optical transmission-reflection “control agents” for a variety of products that require sharp transitions between regions of high and low absorption, i.e., where the material is largely transparent and where it is largely opaque. A key physical feature of many suitable nanosize spherical particles is “optical resonance”, which causes radiation of a characteristic wavelength to interact with the particles so as to produce “absorption cross-sections” greater than unity in certain spectral regions; in other words, more radiation can be absorbed by the particle than actually falls geometrically on its maximum cross-sectional area. Conventional pigments offer absorption cross-sections that can only asymptotically approach, but never exceed, a value of 1, whereas resonant particles can exhibit cross-sections well in excess of (e.g., 3-5 times) their physical diameters.

Unfortunately, the physical properties of most materials, suitable for manufacturing of such resonant particles, result in the absorption peaks being located in undesirable spectral bands. For example, many metals exhibit the plasmon resonance in the ultraviolet region of the electromagnetic spectrum, thus making these materials unusable for production of visible range colorants. Either varying the refraction properties of a carrier or the size of the particles may introduce variation in absorption peak. Both of these methods, however, would produce undesirable effects such as excessive scattering by the particles or absorption by the carrier.

The need, therefore, exists for compositions and methods of manufacture of optically resonant, narrow-band frequency response nanoparticles of equal size, equal shape, and equal chemistry that would allow for tuning the peak of resonance absorption through a desired spectral band.

### SUMMARY OF THE INVENTION

In one embodiment, the present invention is an electromagnetic radiation-absorbing particle comprising (a) a conductive core, and (b) a dielectric shell encapsulating the conductive core. The size of the core, the material of the core, the thickness of the shell and the material of the shell are such that the particle exhibits a peak of absorption in a predetermined range of wavelengths.

In another embodiment, the present invention is a method of manufacturing a particle that absorbs electromagnetic radiation in a predetermined range, comprising the step of encapsulating a core with a shell. The core comprises a conductive material and the shell comprises a dielectric material wherein the size of the core, the material of the core, the thickness of the shell and the material of the shell such that the particle exhibits a peak of absorption in a predetermined range of wavelengths.

In another embodiment, the present invention is an electromagnetic radiation-absorptive material for substantially blocking passage of a predetermined range of radiation, comprising a carrier material, and a particulate material dispersed in the carrier material. The particulate material comprises primary particles, said primary particles comprising (a) a conductive core, and (b) a dielectric shell encapsulating the conductive core. The size of the core, the material of the core, the thickness of the shell and the material of the shell are such that the particle exhibits a peak of absorption in a predetermined range of wavelengths.

Sunscreens, UV blockers, filters, ink, paints, lotions, gels, films, textiles and other solids, which have desired color properties, may be manufactured comprising the aforementioned radiation-absorbing material.

In yet further embodiments the particles of the present invention may be attached to antibodies, peptides, nucleic acids, saccharides, lipids and other biological polymers as well as small molecules. Such assemblies may be used in medical, biotechnological, chemical detection and the like applications.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a plot of the real parts of the dielectric constants of TiN, HfN, and ZrN as functions of wavelength.

FIG. 2 is a 3-dimensional plot that shows absorption cross-section of ZrN spheres as a function of both radius and wavelength.

FIG. 3 is a 3-dimensional plot that shows the absorption of a specified amount of TiN spheres as a function of both radius and wavelength.

FIG. 4 is a plot of absorption cross-section of TiN spheres in three different media with different refraction indices.

FIG. 5 is a plot of absorption (solid) and extinction (dash) cross-sections of spheres with silver cores and titanium oxide shells.

FIG. 6 is a plot of absorption (solid) and extinction (dash) cross-sections of spheres with titanium oxide cores and silver shells.

FIG. 7 is a plot of absorption (solid) and extinction (dash) cross-sections of spheres with titanium nitride cores and silver shells.

FIG. 8 is a plot of absorption (solid) and extinction (dash) cross-sections of spheres with titanium nitride cores and silver shells.

FIG. 9 is a plot of absorption (solid) and extinction (dash) cross-sections of spheres with aluminum cores and zirconium nitride shells.

FIG. 10 is a plot of absorption (solid) and extinction (dash) cross-sections of spheres with ZrN cores and Si shells.

FIG. 11 is a plot of absorption (solid) and extinction (dash) cross-sections of spheres with ZrN cores and titanium oxide shells.

FIG. 12 is a plot of absorption (solid) and extinction (dash) cross-sections of spheres with ZrN cores and silver shells.

FIG. 13 is a plot of absorption (solid) and extinction (dash) cross-sections of spheres with ZrN cores and aluminum shells.

FIG. 14 is a plot of absorption (solid) and extinction (dash) cross-sections of spheres with TiN cores and silicon shells.

FIG. 15 is a plot of absorption (solid) and extinction (dash) cross-sections of spheres with TiN cores and titanium oxide shells.

FIG. 16 is a plot of absorption (solid) and extinction (dash) cross-sections of spheres with aluminum cores and silicon shells.

FIG. 17 is a plot of absorption (solid) and extinction (dash) cross-sections of spheres with silver cores and silicon shells.

FIG. 18 is a plot of absorption (solid) and extinction (dash) cross-sections of spheres with magnesium cores and silicon shells.

FIG. 19 is a plot of absorption (solid) and extinction (dash) cross-sections of spheres with chromium cores and ZrN shells.

FIG. 20 is a schematic representation of the manufacturing process that can be used to produce the particles of the present invention.

FIG. 21 shows a detailed schematic diagram of the nanoparticles production system.

FIG. 21A shows a detailed schematic diagram of a nonoparticle produced by the method as illustrated in FIG. 21.

FIG. 22 depicts the steps of particle formation.

FIG. 23 is a plot of absorption (solid) and extinction (dash) cross-sections of spheres with titanium nitride cores and silver shells.

FIG. 24 is a plot of absorption (solid) and extinction (dash) cross-sections of spheres with ZrN cores and silver shells.

FIG. 25 is a plot of absorption (solid) and extinction (dash) cross-sections of spheres with ZrN cores and aluminum shells.

FIG. 26 is a plot of absorption (solid) and extinction (dash) cross-sections of spheres with aluminum cores and TiO₂ shells in the UV range.

FIG. 27 is a plot of light transmission as a function of wavelength through a coating containing spheres with Al cores and TiO₂ shells of variable thickness at the indicated load factor.

FIG. 28 is a plot of light transmission as a function of wavelength through a coating containing spheres with Al cores and TiO₂ shells of the indicated thickness for a range of load factors.

FIG. 29 is a plot of light transmission as a function of wavelength through a coating containing spheres with Al cores and Si shells of variable thickness at the indicated load factor.

FIG. 30 is a plot of absorption (solid) and extinction (dash) cross-sections of spheres with Al cores and aluminum oxide shells of variable thickness.

FIG. 31 is a plot of absorption (solid) and extinction (dash) cross-sections of spheres with Al cores and silver shells of variable thickness.

### DETAILED DESCRIPTION OF THE INVENTION

Prior to discussing the details of the preferred embodiments of the present invention, certain terms used herein are defined as follows:

An electrical conductor is a substance through which electrical current flows with small resistance. The electrons and other free charge carriers in a solid (e.g., a crystal) can to possess only certain allowed values of energy. These values form levels of energetic spectrum of a charge carrier. In a crystal, these levels form groups, known as bands. The electrons and other free charge carriers have energies, or occupy the energy levels, in several bands. When voltage is applied to a solid, charge carriers tend to accelerate and thus acquire higher energy. However, to actually increase its energy, a charge carrier, such as electron, must have a higher energy level available to it. In electrical conductors, such as metals, the uppermost band is only partially filled with electrons. This allows the electrons to acquire higher energy values by occupying higher levels of the uppermost band and, therefore, to move freely. Pure semiconductors have their uppermost band filled. Semiconductors become conductors through impurities, which remove some electrons from the full uppermost band or contribute some electrons to the first empty band. Examples of metals are silver, aluminum, and magnesium. Examples of semiconductors are Si, Ge, InSb, and GaAs.

A semiconductor is a substance in which an empty band is separated from a filled band by an energetic distance, known as a band gap. For comparison, in metals there is no band gap above occupied band. In a typical semiconductor the band gap does not exceed about 3.5 eV. In semiconductors the electrical conductivity can be controlled by orders of magnitude by adding very small amounts of impurities known as dopants. The choice of dopants controls the type of free charge carriers. The electrons of some dopants may be able to acquire energy by using the levels of the uppermost band. Some dopants provide the necessary unoccupied energy levels, thus allowing the electrons of the atoms of a solid to acquire higher energy levels. In such semiconductors, the free charge carriers are positively charged “holes” rather than negatively charged electrons. Semiconductor properties are displayed by the elements of Group IV as well as compounds that include elements of Groups II, III, V, and VI. Examples are Si, AlP, and InSb.

A dielectric material is a substance that is a poor conductor of electricity and, therefore may serve as an electrical insulator. In a dielectric, the conduction band is completely empty and the band gap is large so that electrons cannot acquire higher energy levels. Therefore, there are few, if any, free charge carriers. In a typical dielectric, the conducting band is separated from the valence band by a gap of greater than about 4 eV. Examples include porcelain (ceramic), mica, glass, plastics, and the oxides of various metals, such as TiO₂. An important property of dielectrics is a sometimes relatively high value of dielectric constant.

A dielectric constant is the property of a material that determines the relative speed at which an electrical signal, current or light wave, will travel in that material. Current or wave speed is roughly inversely proportional to the square root of the dielectric constant. A low dielectric constant will result in a high propagation speed and a high dielectric constant will result in a much slower propagation speed. (In many respects the dielectric constant is analogous to the viscosity of the water.) In general, the dielectric constant is a complex number, with the real part giving reflective surface properties, and the imaginary part giving the radio absorption coefficient, a value that determines the depth of penetration of an electromagnetic wave into media.

Refraction is the bending of the normal to the wavefront of a propagating wave upon passing from one medium to another where the propagation velocity is different. Refraction is the reason that prisms separate white light into its constituent colors. This occurs because different colors (i.e., frequencies or wavelengths) of light travel at different speeds in the prism, resulting in a different amount of deflection of the wavefront for different colors. The amount of refraction can be characterized by a quantity known as the index of refraction. The index of refraction is directly proportional to the square root of the dielectric constant.

Total internal reflection: At an interface between two transparent media of different refractive index (glass and water), light coming from the side of higher refractive index is partly reflected and partly refracted. Above a certain critical angle of incidence, no light is refracted across the interface, and total internal reflection is observed.

Plasmon (Froehlich) Resonance: As used herein, plasmon (Froehlich) resonance is a phenomenon which occurs when light is incident on a surface of a conducting materials, such as the particles of the present invention. When resonance conditions are satisfied, the light intensity inside a particle is much greater than outside. Since electrical conductors, such as metals or metal nitrides, strongly absorb electromagnetic radiation, light waves at or near certain wavelengths are resonantly absorbed. This phenomenon is called plasmon resonance, because the absorption is due to the resonance energy transfer between electromagnetic waves and the plurality of free charge carriers, known as plasmon. The resonance conditions are influenced by the composition of a conducting material.

### Introductory Information on Froehlich (Plasmon) Resonance.

The property which is of importance here is the fact that in many conductors, the real part of the dielectric constant is negative for ultraviolet and optical frequencies. The origin of this effect is known: free conduction electrons in a high frequency electric field exhibit an oscillatory motion. For unbound electrons, this electron motion is 180 degrees out of phase with the electric field. This phenomenon is well known in many resonators, even simple mechanical ones. A mechanical example is provided by the motion of a tennis ball attached by a weak rubber band to a hand moving rapidly back and forth. When the hand is in its maximum positive excursion on an imagined x-axis, the tennis ball would be at its maximum negative excursion on the same axis, and vise versa.

The weakly bound or unbound electrons in a high frequency electric field act basically in the same way. Electronic polarization, i.e. a measure of the responsiveness of electrons to external field, is therefore negative. Since in elementary electrostatics it is known that the polarization is proportional to ε−1, where ε is a so-called “dielectric constant” (actually, a function of wavelength, or frequency, of an external field), it follows that ε has to be smaller than one—it may in fact even be negative.

As mentioned above, the dielectric constant is a complex number, proportional to the index of refraction. In tables of optical constants of metals one finds usually tabulated the real and imaginary parts of the index of refraction, N and K, as a function of wavelength. The dielectric constant is the square of the index of refraction, or

εᵣₑₐₗ+jε_{imag}=(N+jK)²=N²−K²+2jNK

or

εᵣₑₐₗ=N²−K²

ε_{imag}=2NK

and thus it may be seen that εᵣₑₐₗ is negative when K is larger than N. A look at the above-alluded tables of optical constants reveals that indeed this condition is frequently satisfied.

It is also possible to estimate electrical field inside a small dielectric sphere using an electrostatic approximation. Consider a case where the wavelength of the incident electromagnetic wave is much larger than the sphere radius. In this case, the sphere is surrounded by an electric field, which is approximately constant over the dimensions of the sphere. From elementary electrostatics we obtain the magnitude of the field inside of the sphere:

$${E}_{inside} = {E}_{outside} \frac{3 {ɛ}_{outside}}{2 {ɛ}_{outside} + {ɛ}_{inside}}$$

where E_{outside} is the surrounding field, E_{inside} is the field inside the sphere and ε_{inside} and ε_{outside} are the relative dielectric constants inside the sphere and in the surrounding medium, respectively. From the above equation it is apparent that the field inside the sphere would become infinitely large if the condition

2ε_{outside}+ε_{inside}=0

would be satisfied. Since the dielectric constants are not real, the field would become large but not infinite.

In case of an oscillating electric field that is a part of the light wave, that large field would of course also result in a correspondingly large absorption by the metal. This field enhancement is the cause of strong absorption peaks produced in metals nanospheres. Taking into account the complex dielectric constant, one can calculate the approximate absorption cross-section, provided that the imaginary part of the dielectric constant is small. Leaving out a few steps, one finds for for the cross-section Q_{abs}:

$${Q}_{abs} = 12 x \frac{{ɛ}_{medium} {ɛ}_{imag}}{{( {ɛ}_{real} + 2 {ɛ}_{medium} )}^{2} + {ɛ}_{imag}^{2}}$$

In the above equation ε_{medium} is the dielectric constant of the medium, εᵣₑₐₗ and ε_{imag} are the real and imaginary parts of the dielectric constant of the metal sphere. The quantity x is given by

x=2πrN_{medium}/λ

where r is the sphere radius and λ is the wavelength. Again when that part of the denominator that is in brackets becomes zero, a maximum absorption is expected. For large values of absorption with a distinct and clearly delineated absorption region ε_{imag} should stay small. It can be seen that the maximum absorption wavelength shifts when the dielectric constant of the medium is changed. This is one of the ways of fine-tuning the absorption range for a given conductor.

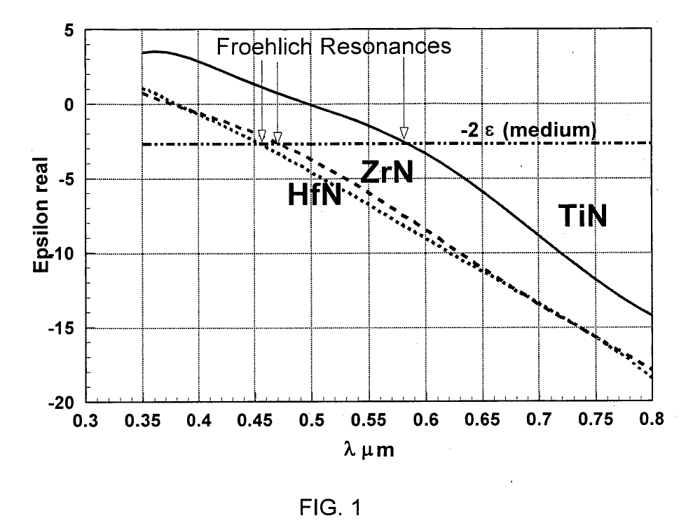

Since, for different materials, εᵣₑₐₗ are different functions, the resonant absorption due to plasmon effect occurs at different wavelengths, as shown in FIG. 1. FIG. 1 shows the real dielectric constant of three metallic Nitrides exhibiting a Froehlich Resonance. The Froehlich resonance frequency is determined by the position where the epsilon (real) curves intersect the line marked “−2 epsilon (medium)”.

### The Shape and the Size of a Particle

The shape of the particle is important. The field inside an oblate particle, such as a disk, in relation to the field outside of that particle is very different from the field inside spherically shaped particle. If the disk lies perpendicular to the direction of the field lines then

$${E}_{inside} = \frac{{ɛ}_{outside}}{{ɛ}_{inside}} {E}_{outside}$$

Here the resonance with the large absorption would occur at such a wavelength, where ε_{inside}=0. If the disk were thin and aligned with the field, then E_{inside}=E_{outside} and no singularity and thus no resonance would occur at all. In general, the shape of the particle is preferably substantially spherical in order to prevent anisotropic absorption effects.

There is a small shift in wavelength of the absorption that comes from particle size. As the particle becomes larger the above simple assumptions break down. Without proof, increase in particle size shifts the absorption peak slightly towards the red, i.e. longer wavelengths. Larger particles also become less effective as absorbers because the material occupying the innermost portion of the sphere never sees the electromagnetic radiation that they might absorb because the outer layers have already absorbed the incident resonance radiation. For larger spheres the resonance character gradually vanishes. The absorption and extinction cross sections start to be less pronounced as the size of the sphere grows. Absorption and especially extinction shifts also more to the longer wavelengths.

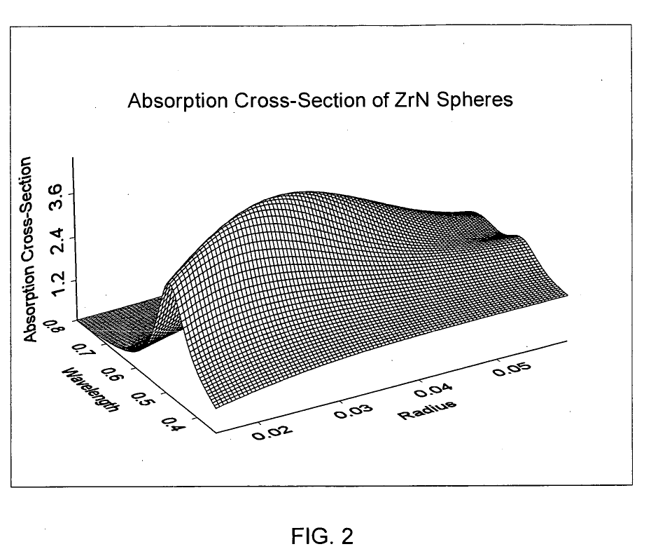

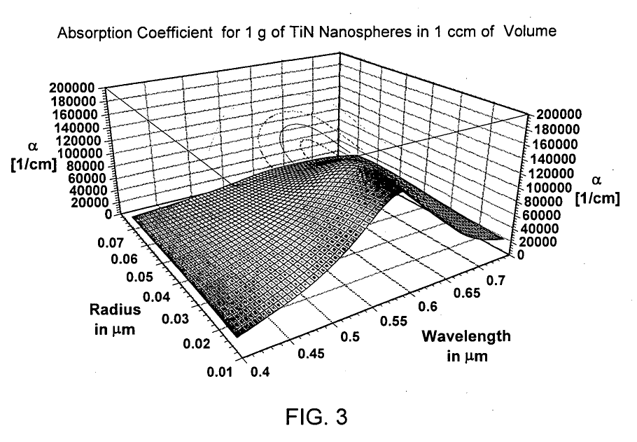

For further illustration of the behavior of the absorption cross-sections see the three-dimensional plot in FIG. 2, which shows a 3-dimensional plot of absorption cross-section of ZrN plotted against radius and wavelength. To actually determine optimal particle sizes, it is best to plot transmission, absorption and extinction. While the absorption cross-section decreases for small particles, there are many more small particles present per unit weight than big particles. Interestingly, it appears that small particles of a given total mass absorb just about as well as somewhat larger particles with the same total mass. Most importantly small particles do not scatter. These points are illustrated for TiN with FIG. 3 showing the absorption coefficient of 1 g of TiN spheres suspended in 1 cm³ of solution with an index of N=1.33. Small particles give the best absorption, and below a critical radius of about 0.025 micrometer it does not matter how small the particles are.

### The Effect of the Media

There is also an absorption shift that depends upon the dielectric constant of the medium carrying the particles of the present invention. The Drude theory gives an approximate value for the real part of the dielectric constant that varies as

$${ɛ}_{real} = 1 - \frac{{v}_{plasma}^{2}}{{v}^{2}}$$

where νₚₗₐₛₘₐ is the so-called plasma frequency and ν is the frequency of the light wave. The plasma frequency usually lies somewhere in the ultra violet portion of the spectrum. Gold spheres have an absorption peak near 5200 A. TiN, ZrN and HfN, which look golden colored, have a peaks at shorter and longer wavelengths as we shall show below. TiN colloids have been seen to exhibit blue colors due to green and red absorption.

The above described behavior of the dielectric constants allows us to estimate how much the absorption peak shifts when the dielectric constant of the medium is changed. Using a simple Taylor series expansion of the above expressions up to the first order, we obtain:

$$Δλ = {λ}_{0} \frac{Δ {ɛ}_{medium}}{3}$$

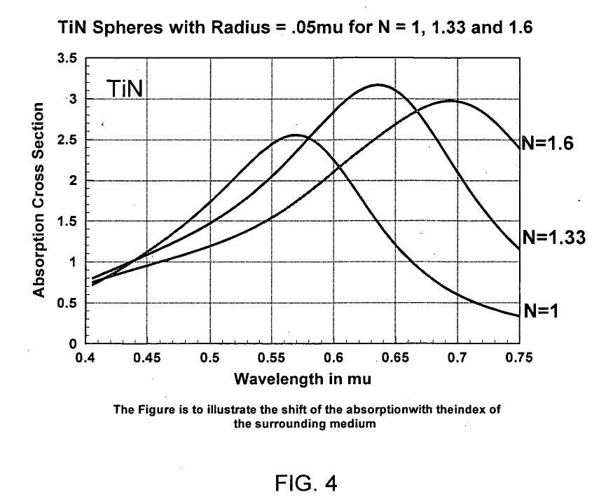

If the absorption maximum occurs at 6000 A, and we increase the dielectric constant of the medium by 0.25, then the absorption peak shifts up by 500 A to 6500 A. If we decrease the dielectric constant then the absorption shifts to shorter wavelengths. This point is illustrated in FIG. 4, which shows absorption cross-section for TiN spheres with a radius of 50 nm in media with three different indices of refraction: 1, 1.33, and 1.6.

### Preferred Embodiments of the Invention

The present invention relates to composite materials capable of selective absorption of electromagnetic radiation within a chosen, predetermined portion of the electromagnetic spectrum while remaining substantially transparent outside this region. More specifically, in the preferred embodiment, the instant invention provides small particles, said particles having an inner core and an outer shell, wherein the shell encapsulates the core, and wherein either the core or the shell comprises a conductive material. The conductive material preferably has a negative real part of the dielectric constant in a predetermined spectral band. Furthermore, either (i) the core comprises a first conductive material and the shell comprises a second conductive material different from the first conductive material, or (ii) either the core or the shell comprises a refracting material with a large refraction index approximately greater than about 1.8.

For example, in one embodiment, the particle of the instant invention comprises a core, made of a conducting material, and a shell, comprising a high-refractive index material. In another embodiment, the particle comprises a core of high-refractive index material and a shell of conductive material. In yet another embodiment, the particle of the present invention comprises a core, composed of a first conducting material, and a shell comprising a second conducting material, with the second conductive material being different from the first conducting material.

In one embodiment, the present invention is an electromagnetic radiation-absorbing particle comprising (a) a conductive core, and (b) a dielectric shell encapsulating the conductive core. The size of the core, the material of the core, the thickness of the shell and the material of the shell are such that the particle exhibits a peak of absorption in a predetermined range of wavelengths. In one embodiment, wherein the shell is substantially continuous. The particle of the present invention can be substantially spherical.

The particles of the present invention can have a diameter from about 0.1 nm to about 300 nm. In one embodiment, the material of the core can be selected from a group consisting of Ag, Al, Mg, Cu, Ni, Cr, TiN, ZrN, and HfN. In another embodiment, the material of the shell can be selected from the group consisting of Si, SiO₂, ZrO₂ TiO₂ and Al₂O₃.

The particle of the present invention preferably include the core and the shell selected so that the particle exhibits a peak of absorption in a range of wavelengths from about 200 nm to about 700 nm.

In another embodiment, the present invention is a method of manufacturing a particle that absorbs electromagnetic radiation in a predetermined range, comprising the step of encapsulating a core with a shell. Preferably, the core comprises a conductive material and the shell comprises a dielectric material wherein the size of the core, the material of the core, the thickness of the shell and the material of the shell such that the particle exhibits a peak of absorption in a predetermined range of wavelengths.

In another embodiment, the present invention is an electromagnetic radiation-absorptive material for substantially blocking passage of a predetermined range of radiation, comprising a carrier material, and a particulate material dispersed in the carrier material, wherein the particulate material comprises primary particles of the present invention.

In one embodiment, the carrier can be selected from the group consisting of glass, polyethylene, polypropylene, polymethylmethacrylate, polystyrene, and copolymers thereof.

In one embodiment, the material comprising one or more distinct particulate materials. The material can be selected from the group consisting of ink, paint, lotion, gel, film and solid. In one embodiment, the primary particles are further embedded in beads.

In certain embodiments, the carrier material is a textile, textile-like, or a foam matrix selected from a group consisting of gauze, rayon, polyester, polyurethane, polyolefin, cellulose and its derivatives, cotton, acrylic copolymers (Orlon®), polyamides (Nylon®), and hydrogel polymeric materials. In other embodiments, the material is attached to a self-adhering elastomeric bandage.

In one preferred embodiment, the particle exhibits an absorption cross-section greater than unity in a predetermined spectral band. In another embodiment the particle is spherical or substantially spherical, having a diameter from about 1 nm to about 300 nm. The preferred shell thickness is from about 0.1 nm to about 20 nm.

Any material having a refractive index greater than about 1.8 and any material possessing a negative real part of the dielectric constant in a desirable spectral band may be used to practice the present invention. In the preferred embodiment these materials comprise Ag, Al, Mg, Cu, Ni, Cr, TiN, ZrN, HfN, Si, TiO₂, ZrO₂, and others.

The shift of the resonance absorption across a predetermined spectral band is achieved, in one embodiment, by varying the thickness of the shell, and in another embodiment, by varying the materials of the shell and/or the core. In yet another embodiment, both may be varied.

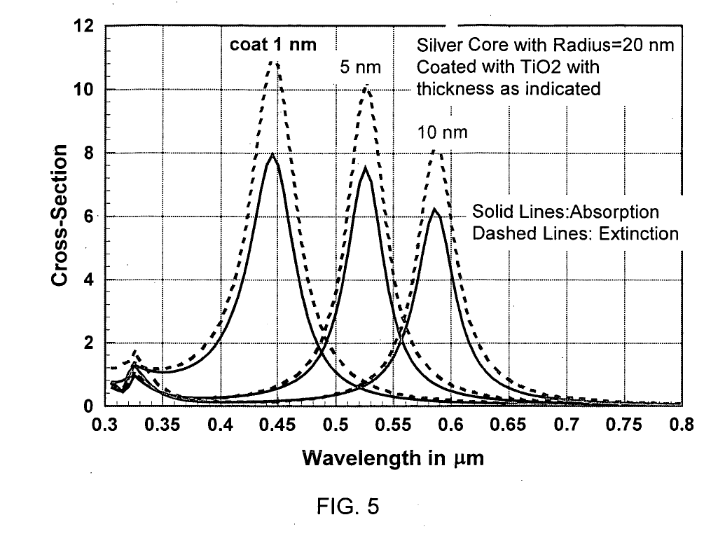

In another embodiment, the overall diameter of the particle stays the same, while the thickness of the shell and the diameter of the core are selected to achieve the desired resonance. In a particle comprising a conductive core and a high-refractive index shell, the thickness of the shell may be adjusted to shift the peak absorption across the UV or visual spectral bands towards the “red” color. This is illustrated in FIG. 5, which shows absorption (solid line) and extinction (dashed line) cross-sections for metallic (silver) core of constant radius (20 nm) coated with a high-refractive material (titanium oxide) of variable thickness (1, 5, and 10 nm).

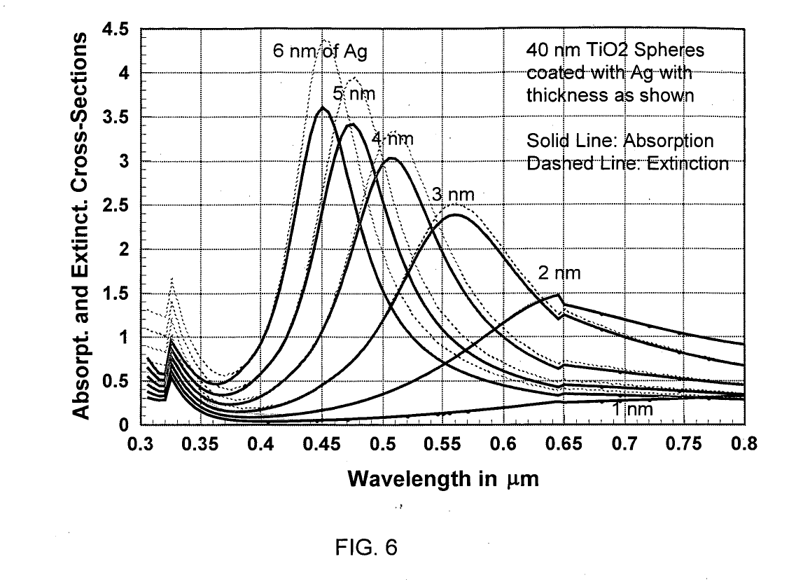

As noted above, most metals have their plasmon resonance frequency in the UV band. This makes it is possible, in a particle comprising a high-refractive index core and a conductive shell, to adjust the thickness of the shell and thus to shift the peak absorption across the visual and into the UV spectral band. This is illustrated in FIG. 6, which shows absorption (solid line) and extinction (dashed line) cross-sections for a core of TiO₂, with a fixed radius of 40 nm, coated with a shell of silver that varies in thickness from 1 to 6 nm.

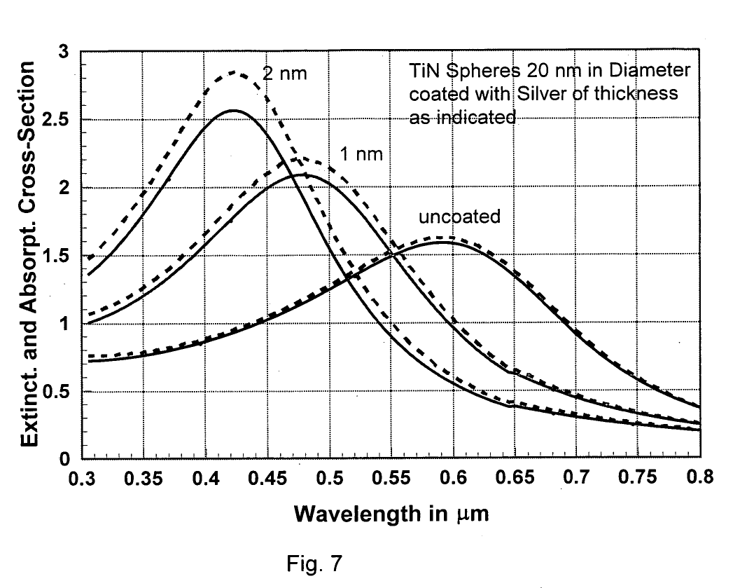

If two conducting materials are used, one in the core and the other in the shell, the particle will have resonance absorption at a wavelength that is between the peaks of each of the conducting materials. This makes it possible, by selecting the materials of the core and of the shell and/or by adjusting the ratio of the thickness of the shell to the diameter of the core, to shift the peak of absorption in either direction across both visible and UV bands. For example, while TiN has its resonance peak in the visible range, silver exhibits resonance absorption in the UV band. As illustrated in FIG. 7, which shows absorption (solid line) and extinction (dashed line) cross-sections for 20 nm-radius TiN spheres coated with either 1 nm or 2 nm thick shell of silver, adjusting the thickness of the silver shell shifts the peak toward the shorter wavelengths.

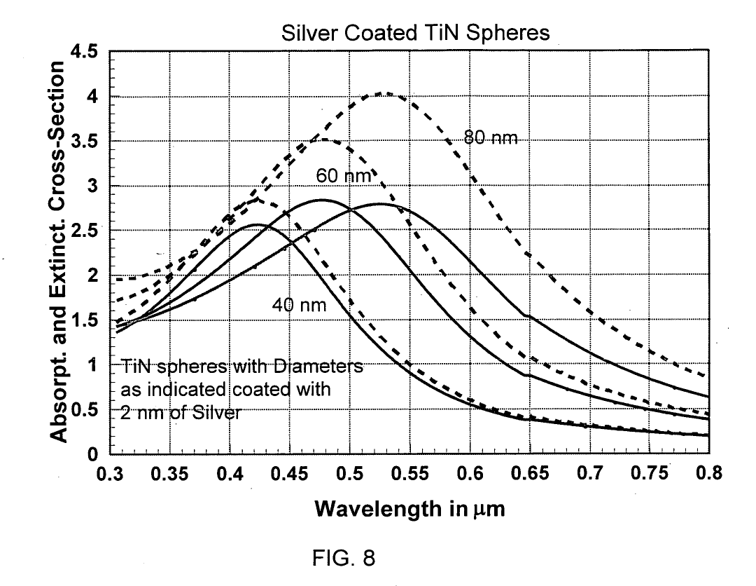

FIG. 8 shows the opposite effect, whereby absorption (solid line) and extinction (dashed line) cross-sections are shifted toward the longer wavelengths by adjusting the radius of the TiN core (40 nm, 60 nm, or 80 nm), while keeping the thickness of a silver shell constant at 2 nm.

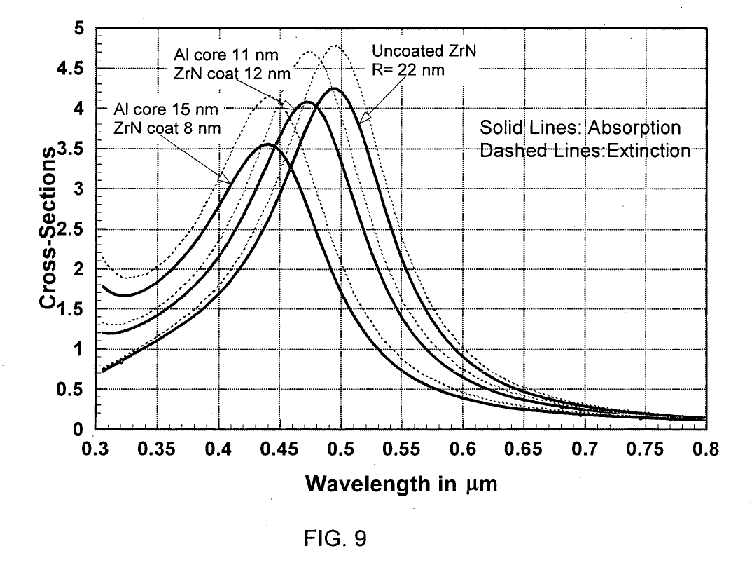

FIG. 9 shows absorption (solid line) and extinction (dashed line) cross-sections for a particle comprising an aluminum core and a ZrN shell, and illustrates how a shift in the peak absorption can be obtained by varying the ratio of the shell thickness to the core diameter while keeping the overall particle diameter constant. A core of aluminum has either 15 nm or 11 nm radius, while the shell of ZrN has either 8 nm or 12 nm thickness.

In the figures described below, the solid lines represent absorption and the dashed lines represent extinction.

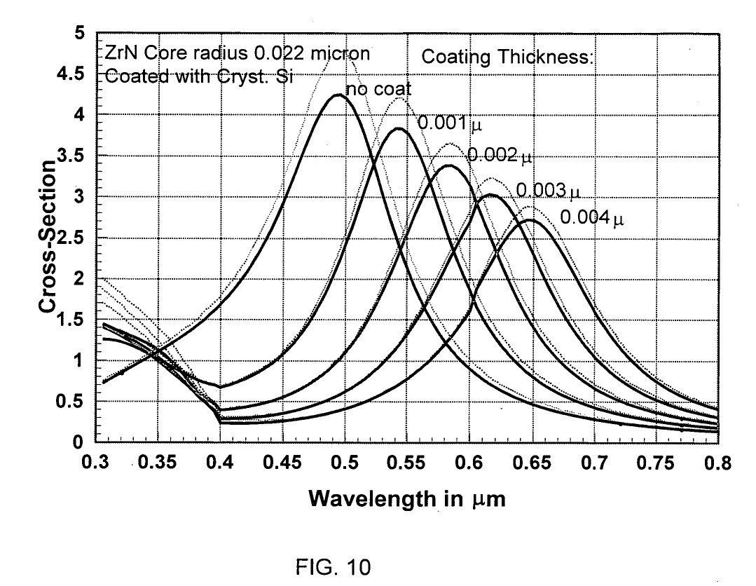

FIG. 10 shows that the resonant absorption peak of a ZrN core, radius 22 nm, coated with a silicon shell, can be shifted depending on the thickness of the shell. Shells are 0, 1, 2, 3, and 4 nm thick.

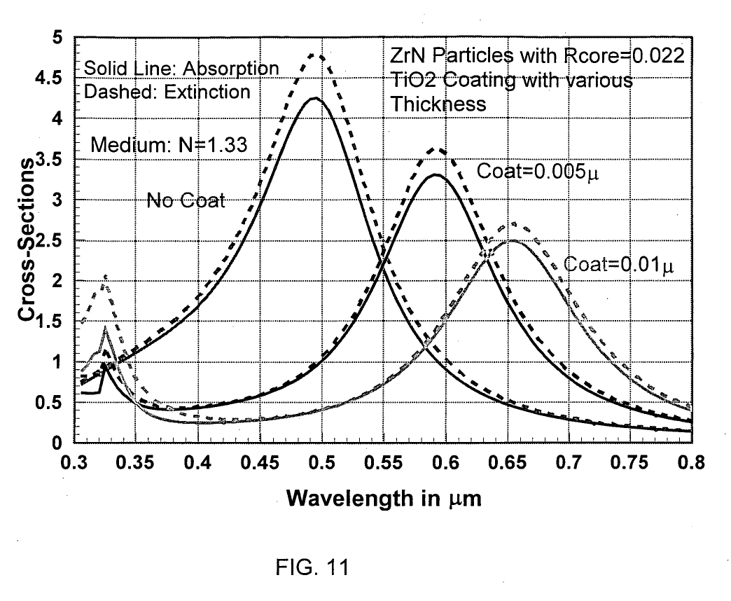

FIG. 11 shows that the resonant absorption peak of a ZrN core, radius 22 nm, coated with a titanium oxide shell, can be shifted depending on the thickness of the shell. Shells are 0 nm, 5 nm, and 10 nm thick. Refraction index of the media is 1.33.

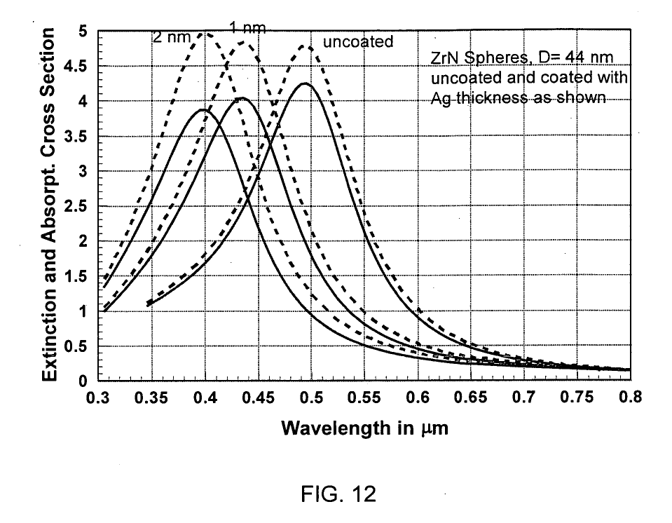

FIG. 12 shows that the resonant absorption peak of a ZrN core, radius 22 nm, coated with a silver shell, can be shifted depending on the thickness of the shell. The shift is toward the shorter wavelengths. Shells are 0 nm, 1 nm, and 2 nm thick.

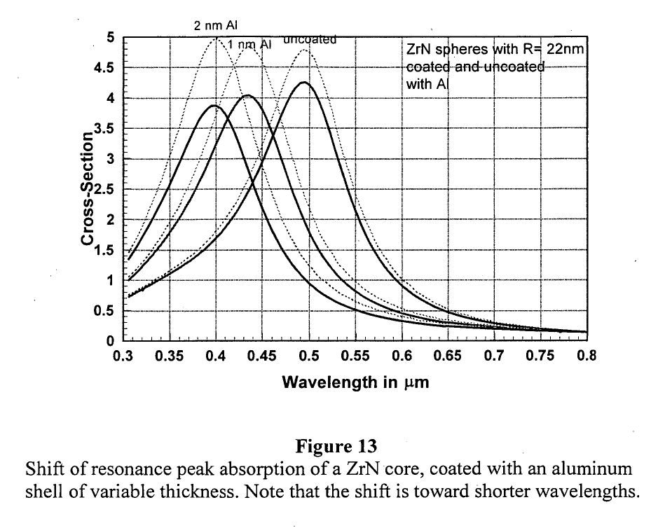

FIG. 13 shows that the resonant absorption peak of a ZrN core, radius 22 nm, coated with an aluminum shell, can be shifted depending on the thickness of the shell. The shift is toward the shorter wavelengths. Shells are 0 nm, 1 nm, and 2 nm thick.

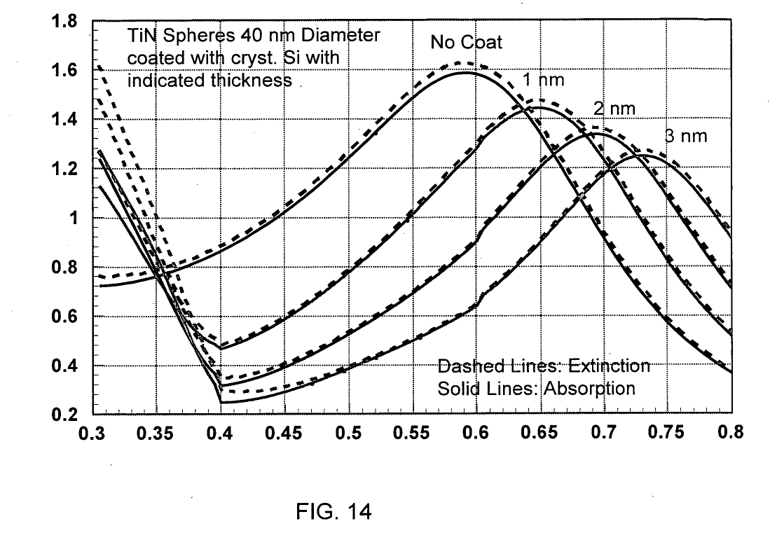

FIG. 14 shows that the resonant absorption peak of a TiN core, radius 20 nm, coated with a silicon shell, can be shifted depending on the thickness of the shell. Shells are 0 nm, 1 nm, 2 nm, 3 nm.

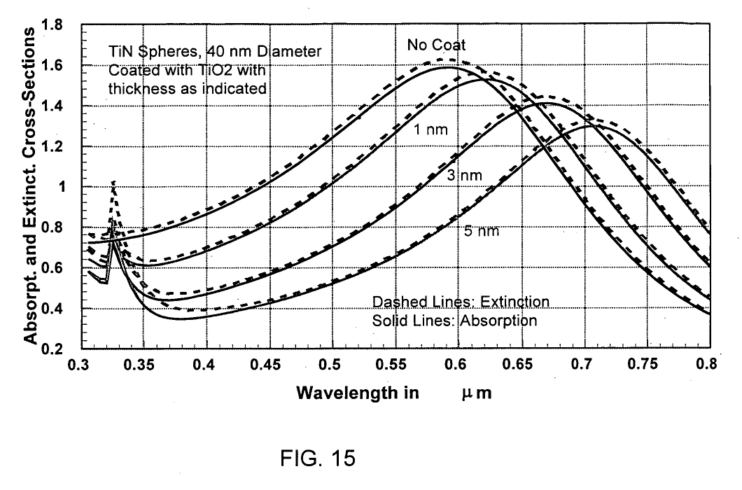

FIG. 15 shows that the resonant absorption peak of a TiN core, radius 20 nm, coated with a titanium oxide shell, can be shifted depending on the thickness of the shell. Shells are 0 nm, 1 nm, 3 nm, 5 nm thick.

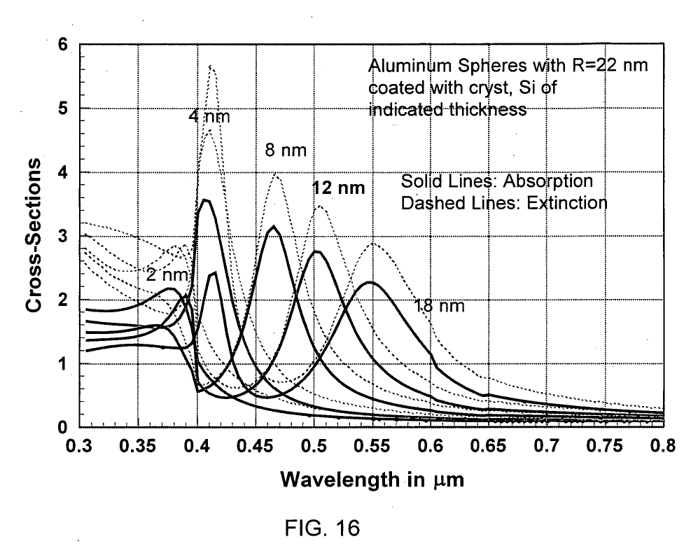

FIG. 16 shows that the resonant absorption peak of an aluminum core, radius 22 nm, coated with a silicon shell, can be shifted depending on the thickness of the shell. Shells are 2 nm, 4 nm, 8 nm, 12 nm, 18 nm thick

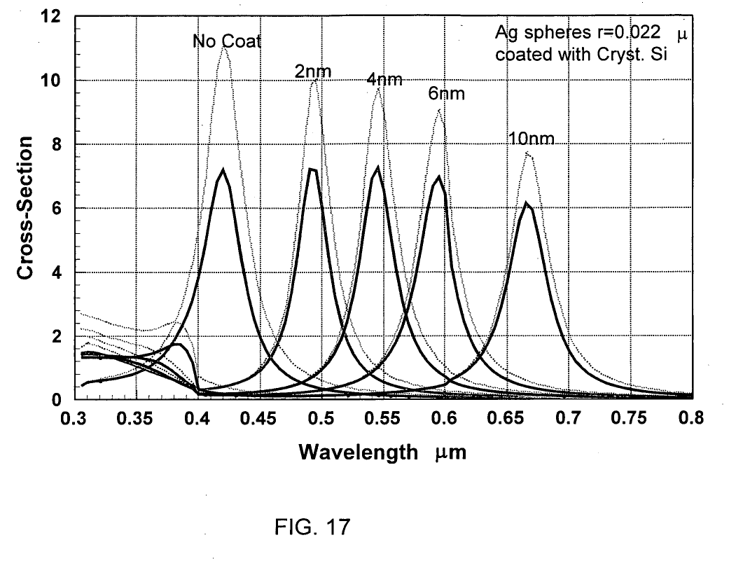

FIG. 17 shows that the resonant absorption peak of a silver core, radius 22 nm, coated with a silicon shell, can be shifted depending on the thickness of the shell. Shells are 0 nm, 2 nm, 4 nm, 6 nm, 10 nm.

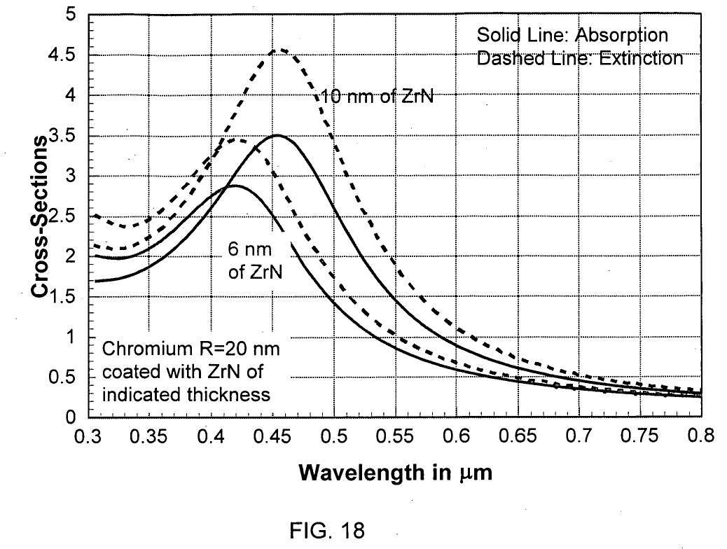

FIG. 18 shows that the resonance of chromium metal can be shifted into the visible band by coating it with ZrN. Cr sphere have radius 20 nm, the shells are 6 nm or 10 nm thick. Medium has N=1.33.

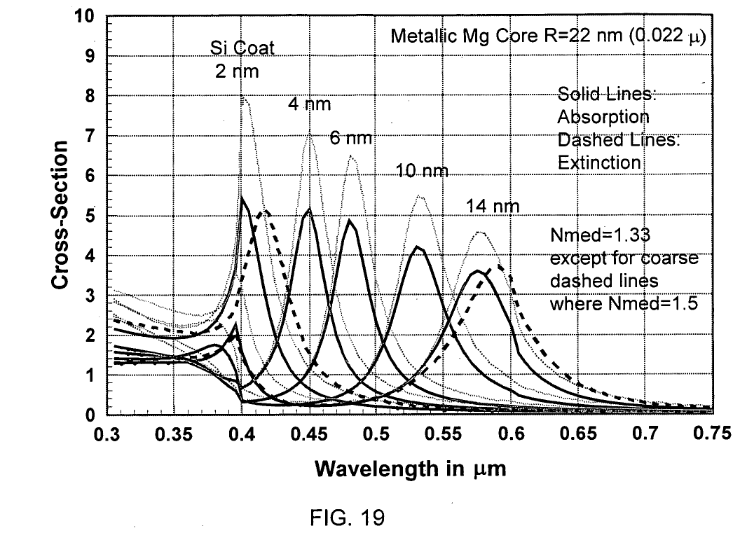

FIG. 19 shows that magnesium spheres, radius 22 nm, coated with a layer of crystalline silicon, give absorption peaks in the visible spectrum. Shells are 2 nm, 4 nm, 6 nm, 10 nm, and 14 nm thick. Media refraction is N=1.33, except for coarse dashed lines, where N=1.5.

### Applications

The present invention can be used in a wide range of applications that include UV blockers, color filters, ink, paints, lotions, gels, films, and solid materials.

It should be noted that resonant nature of the radiation absorption by the particles of the present invention results in (a) absorption cross-section greater than unity and (b) narrow-band frequency response. These properties result in an “optical size” of a particle being greater than its physical size, which allows reducing the loading factor of the colorant. Small size, in turn, helps to reduce undesirable radiation scattering. Low loading factor has an effect on the economy of use. Narrow-band frequency response allows for superior quality filters and selective blockers. The pigments based on the particles of the present invention do not suffer from UV-induced degradation, are light-fast, non-toxic, resistant to chemicals, stable at high temperature, and are non-carcinogenic.

The particles of the present invention can be used to block a broad spectrum of radiation: from ultraviolet (UV) band, defined herein as the radiation with the wavelengths between 200 nm and 400 nm, to the visible band (VIS), defined herein as the radiation with the wavelengths between about 400 nm and about 700 nm. As a non-limiting example, particles of the present invention can be dispersed in an otherwise clear carrier such as glass, polyethylene or polypropylene. The resulting radiation-absorbing material will absorb UV radiation while retaining good transparency in the visible region. A container manufactured from such radiation-absorbing material may be used, for example, for storage of UV-sensitive materials, compounds or food products.

Cores and shells comprising metals can be used to produce particles absorbing in UV band. Alternatively, a film manufactured from a radiation-absorbing material can be used as coating.

Particles with strong, wavelength-specific absorption properties make excellent pigments for use in ink and paint composition. Color is created when a white light passes through or is reflected from a material that selectively absorbs a narrow band of frequencies. Thus cores and shells comprising excellent conducting materials, such as TiN, HfN, and ZrN, as well as other metals and high-refracting index dielectric materials can be used to produced particles absorbing in the visible range and which, therefore, become useful as pigments. Table 1 provides non-limiting examples of the colors that can be achieved using the particles of the present invention.

TABLE 1

| Core | Dia. | Encapsulant | Thickness, | |
|---|---|---|---|---|
| Matl. | nm | Mat | nm | Color |
| ZrN | 30-80 | 0 | 0 | magenta |
| ZrN | 100-120 | 0 | 0 | mag. to blue/green |
| ZrN | 44 | Si | 1 or 2 | magenta |
| ZrN | 44 | Si | 3 or 4 | blue/green |
| ZrN | 44 | TiO2 | 5 | magenta |
| ZrN | 44 | TiO2 | 10 | blue/green |
| ZrN | 44 | Ag | 1 | yellow |
| ZrN | 44 | Ag | 2 | yellow |
| ZrN | 44 | Al | 1 | yellow |
| ZrN | 44 | Al | 2 | yellow |
| TiN | 40 | 0 | 0 | blue/green |
| TiN | 70-100 | 0 | 0 | blue/green |
| TiN | 40 | Si | 1 | blue/green |
| TiN | 40 | Si | 2 | ″ |
| TiN | 40 | Si | 3 | ″ |
| TiN | 20 | Ag | 1 or 2 | yellowish |
| TiN | 40 | Ag | 2 | yellowish |
| TiN | 60 | Ag | 2 | magenta |
| TiN | 80 | Ag | 2 | magenta |
| TiN | 40 | TiO2 | 1 to 5 | blue/green |
| Al | 44 | Si | 4 | yellowish |
| Al | 44 | Si | 8 | yellowish |
| Al | 44 | Si | 12 | magenta |
| Al | 44 | Si | 18 | magenta |
| Ag | 44 | Si | 1 or 2 | yellow |
| Ag | 44 | Si | 4 | magenta |
| Ag | 44 | Si | 10 | green/blue |
| Ag | 40 | TiO2 | 1 | yellow |
| Ag | 40 | TiO2 | 5 or 6 | magenta |

Suitable carriers for the particles of the present invention include polyethylene, polypropylene, polymethylmethacrylate, polystyrene, and copolymers thereof. A film or a gel, comprising ink or paints described above, are contemplated by the present invention.

The particles of the present invention can be further embedded in beads in order to ensure a minimal distance between the particles. Preferably, beads are embedded individually in transparent spherical plastic or glass beads. Beads, containing individual particles can then be dispersed in a suitable carrier material.

The particles of the present invention can also be used as highly effective color filters. Conventional filters often suffer from “soft shoulder” spectral absorption, whereby a rather significant proportion of unwanted frequency bands is absorbed along with the desirable band. The particles of the present invention, by virtue of the resonant absorption, provide a superior mechanism for achieving selective absorption. The color filters can be manufactured by dispersing the particles of the present invention in a suitable carrier, such as glass or plastic, or by coating a desired material with film, comprising the particles of the present invention.

Combining particles of different types within the same carrier material is also contemplated by the instant invention.

Particles of the present invention can be used as signal-producing entities used in biomedical applications such as cytostaining, immunodetection, and competitive binding assays. As a non-limiting example, a particle can be covalently attached to an antibody. Such composition can be used to contact a sample of tissue and illuminated by white light. The visual signal, generated by the particle's absorption of a predetermined frequency band, can be detected by standard techniques known in the art, such as microscopy. One skilled in the art will recognize that entities other than antibodies can be covalently attached to a particle of the present invention. Peptides, nucleic acids, saccharides, lipids, and small molecules are contemplated to be attachable to the particles of the present invention.

Although particles suitable for use in the applications described above can be produced through any number of commercial processes, we have devised a preferred manufacturing method for vapor-phase generation. This method is described in U.S. Pat. No. 5,879,518 and U.S. Provisional Application 60/427,088.

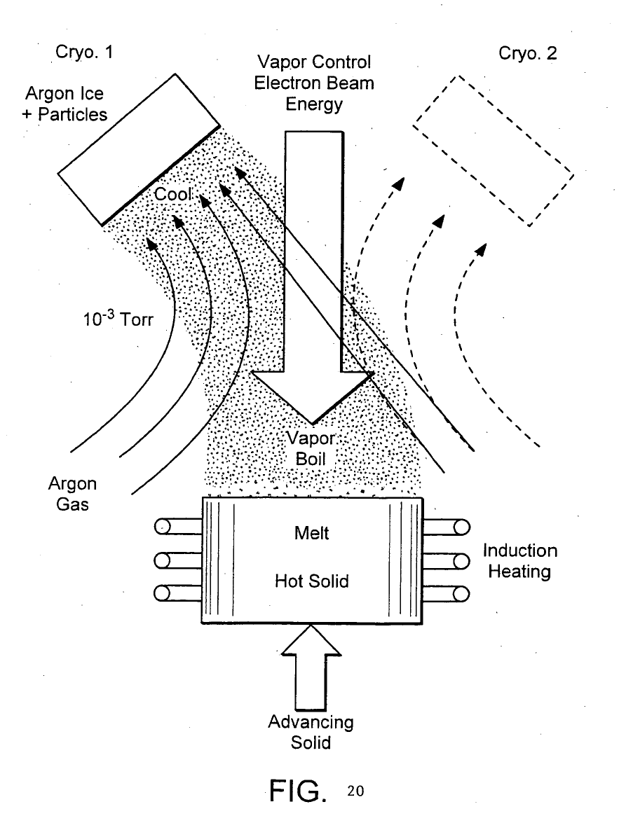

This method, schematically illustrated in FIG. 20, uses a vacuum chamber in which materials used to manufacture cores are vaporized as spheres and encapsulated before being frozen cryogenically into a block of ice, where are collected later. The control means for arriving at monodispersed (uniformly sized) particles of precise stoichiometry and exact encapsulation thickness relate to laminar flow rates, temperatures, gas velocities, pressures, expansion rates from the source, and percent composition of gas mixtures.

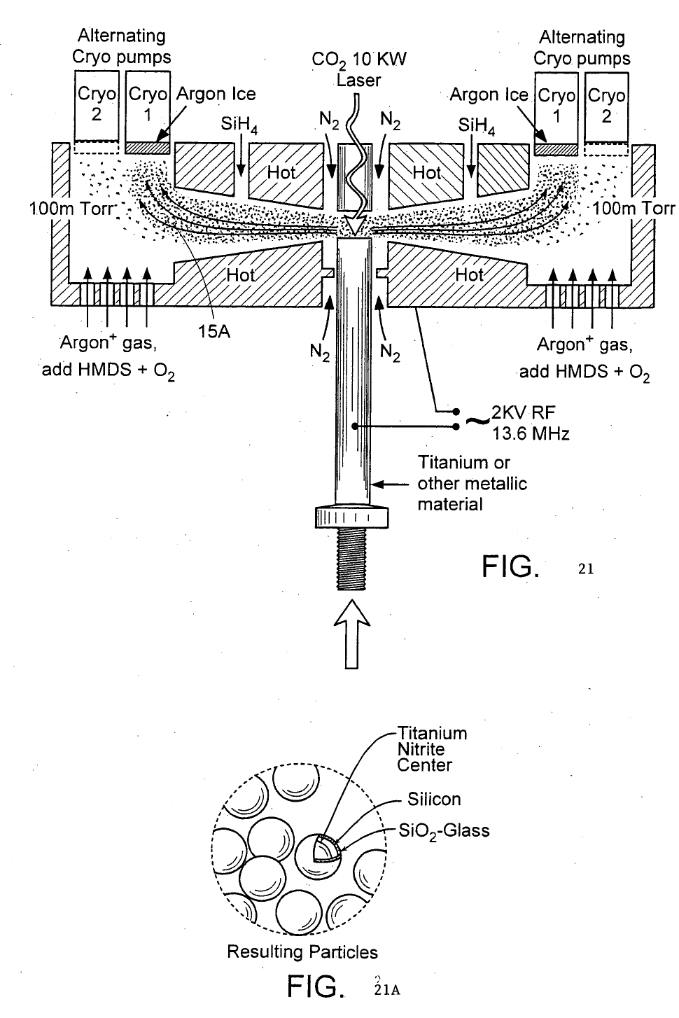

Referring to FIG. 21, in a preferred embodiment, a supply of titanium may be used, as an example. Titanium or other metallic material is evaporated at its face by incident CO₂ laser beam to produce metal vapor droplets. The formation of these droplets can be aided, for narrower size control, by establishing an acoustic surface wave across the molten surface to facilitate the release of the vapor droplets by supplying amplitudinal, incremental mechanical peak energy.

The supply rod is steadily advanced forward as its surface layer is used up to produce vapor droplets. The latter are swept away by the incoming nitrogen gas (N₂) that, at the central evaporation region, becomes ionized via a radio frequency (RF) field (about 2 kV at about 13.6 MHz). The species of atomic nitrogen “N⁺” react with the metal vapor droplets and change them into TiN or other metal nitrides such as ZrN or HfN, depending on the material of the supply rod.

Due to vacuum differential pressure and simultaneous radial gas flow in the conically shaped circular aperture, the particles travel, with minimum collisions, into an argon upstream to reach several alternating cryogenic pumps which “freeze out” and solidify the gases to form blocks of ice in which the particles are embedded.

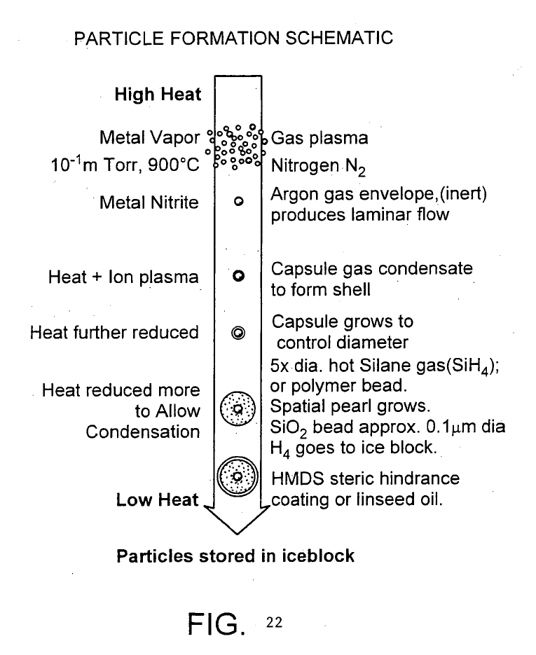

The steps of particle formation are shown in FIG. 22. Here we begin with metal vapor plus atomic nitrogen gas to form metal nitrides. By imparting onto the particles a temporary electric charge, we can keep them apart, and thus prevent collisions, while beginning to grow a thin shell around the nitride core. As non-limiting examples, silicon or TiO₂ can be used, wherein the thickness of the shell is controlled by the rate of supply of silane gas (SiH₄) or a mixture of TiCl₄ and oxygen, respectively.

In a subsequent passage zone, silane gas or a TiCl₄/O₂ mixture are condensed on a still hot nanoparticle to form a SiO₂ or TiO₂ spherical enclosure around each individual particle.

If required, a steric hindrance layer of a surfactant, such as, for example, hexomethyl disiloxane (HMDS), can be deposited on the beads to keep the particles evenly dispersed through a carrier of choice, such as, for example, oil or polymers. Other surfactants can be used in water suspension.

With this manufacturing method, a variety of encapsulated nanoparticles can be produced in large quantities, generating in one single process step the desired resonant-absorption particles and assure their collectability and their uniform size.

### Other Preferred Embodiments

In other embodiments, the present invention is a material that selectively absorbs radiation in the UV band. By adjusting the ratio of the thickness of the shell to the diameter of the core, to shift the peak of absorption in either direction across both visible and UV bands.

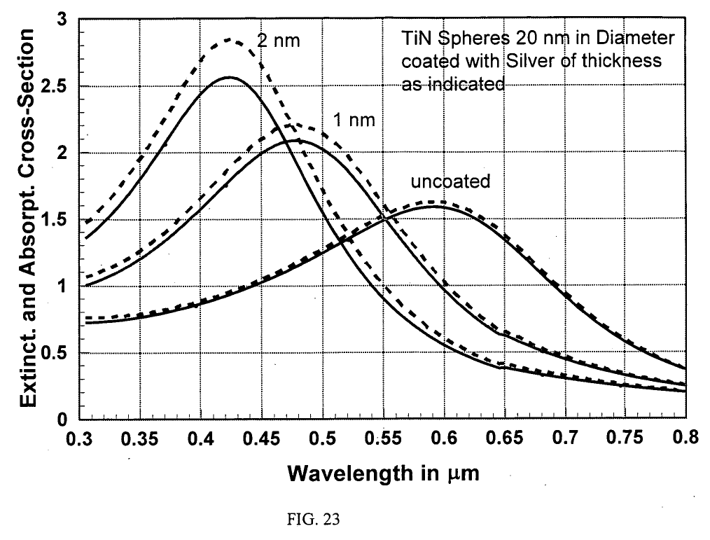

For example, while TiN has its resonance peak in the visible range, silver exhibits resonance absorption near the edge of the UV band. As illustrated in FIG. 23, which shows absorption (solid line) and extinction (dashed line) cross-sections for 20 nm-radius TiN spheres coated with either 1 nm or 2 nm thick shell of silver, adjusting the thickness of the silver shell shifts the peak toward the shorter wavelengths.

In the figures described below, the solid lines represent absorption and the dashed lines represent extinction.

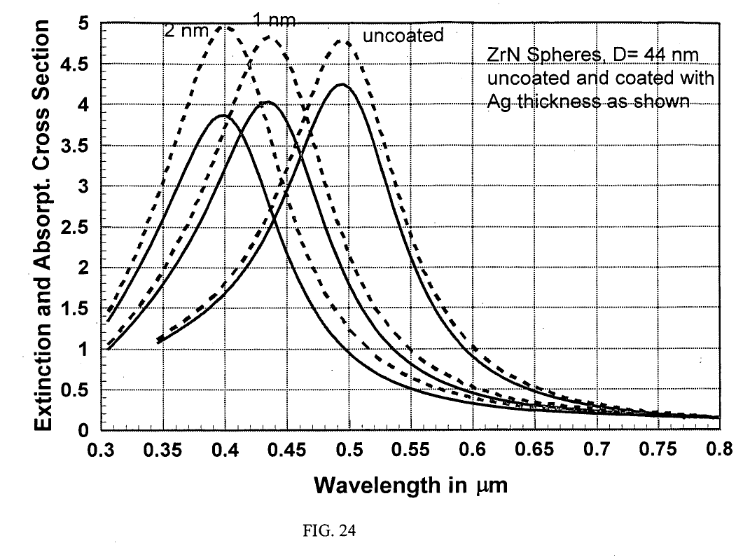

FIG. 24 shows that the resonant absorption peak of a ZrN core, radius 22 nm, coated with a silver shell, can be shifted depending on the thickness of the shell. The shift is toward the shorter wavelengths. Shells are 0 nm, 1 nm, and 2 nm thick.

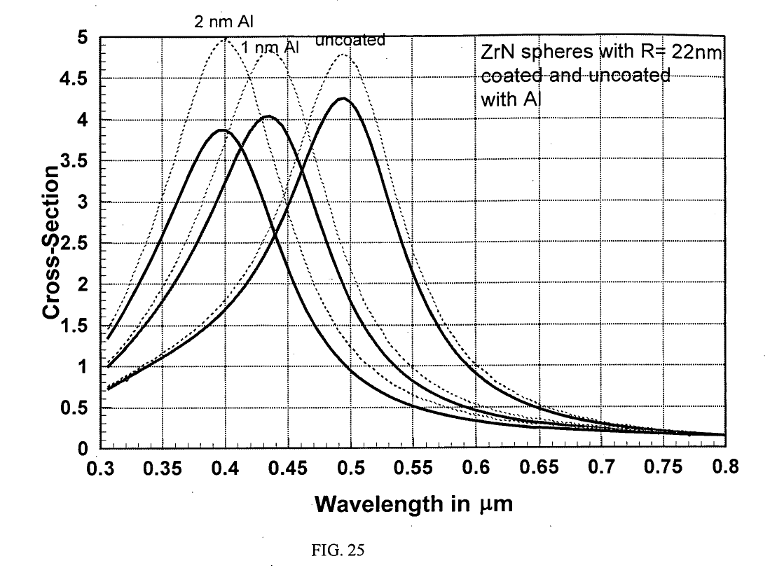

FIG. 25 shows that the resonant absorption peak of a ZrN core, radius 22 nm, coated with an aluminum shell, can be shifted depending on the thickness of the shell. The shift is toward the shorter wavelengths. Shells are 0 nm, 1 nm, and 2 nm thick.

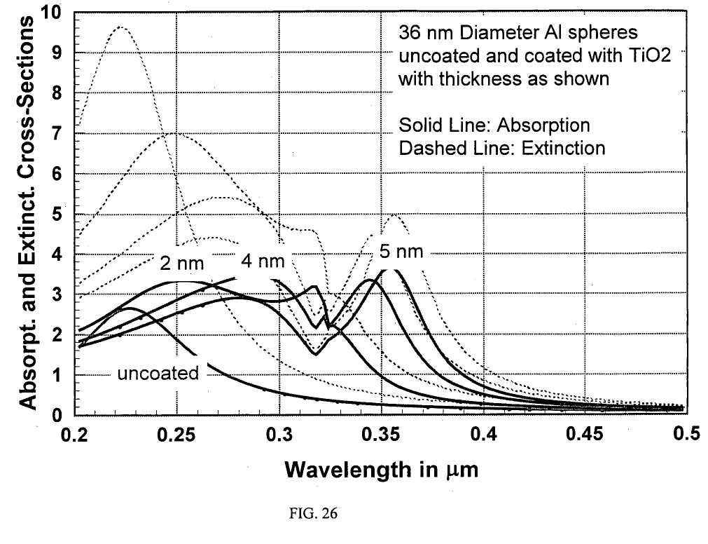

In one embodiment, the core comprises a conducting material and the shell comprises a high refractive index material. This embodiment is illustrated in FIG. 26, which shows absorption (solid line) and extinction (dashed line) cross-sections for aluminum cores, radius 18 nm, coated with a shell of TiO₂ of 2 nm, 4 nm, and 5 nm. As can be seen, the absorption peak may be shifted across the UV spectral band without excessive absorption in the visible range.

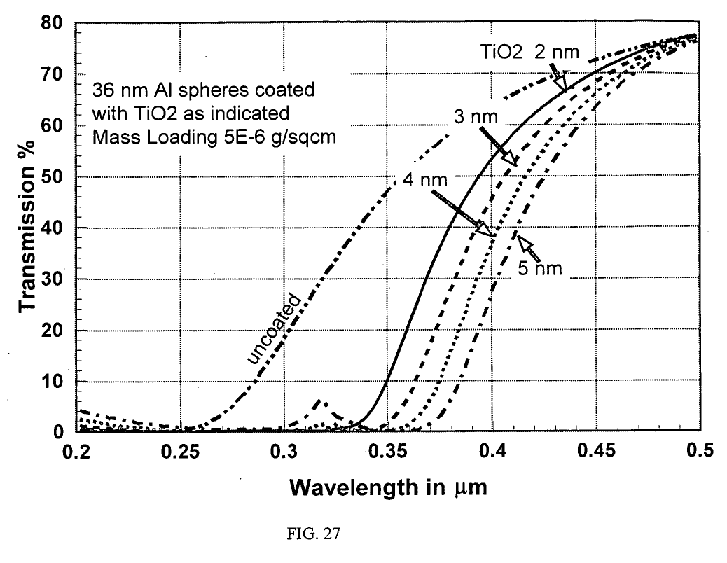

In another embodiment, the particles are dispersed in a carrier at a desired mass loading factor. As illustrated in FIG. 27, the particles, comprising aluminum cores, radius 18 nm, coated with shells of titanium oxide of variable thickness (2 nm, 3 nm, 4 nm, or 5 nm), dispersed in a carrier at a mass loading factor of about 5×10⁻⁶ g/cm², substantially block the transmission of radiation in the ultraviolet range, while remaining transparent in the visible range.

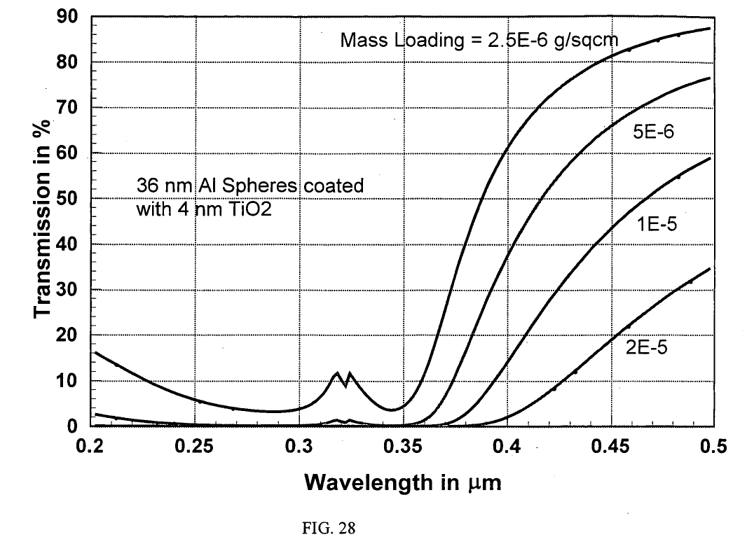

The present invention contemplates a range of mass loading factors that the particles can be dispersed at. FIG. 28 illustrates that the preparation of a carrier and particles of aluminum cores and titanium oxide shells (core radius 18 nm, shell thickness 4 nm) remain absorbent in the UV range at loading factors that vary from 2.0×10⁻⁵ g/cm² to 2.5×10⁻⁶ g/cm².

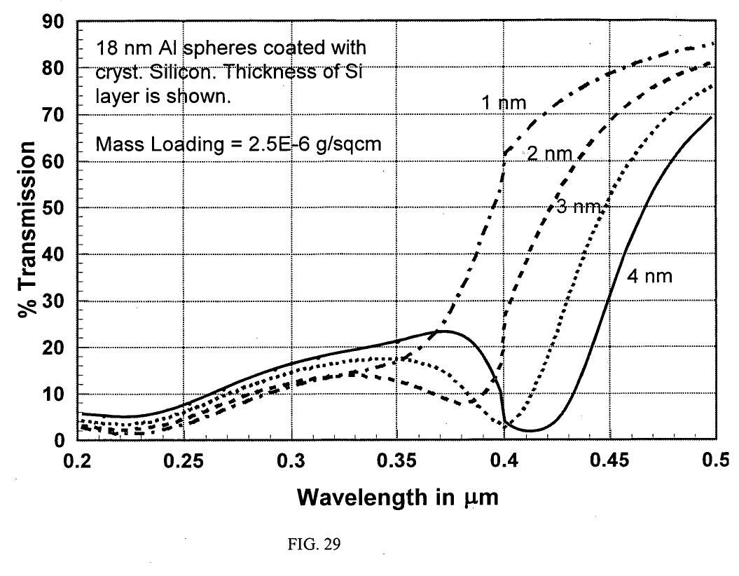

In yet another embodiment, illustrated in FIG. 29, particles of aluminum core, radius 18 nm, coated with a silicon shell of variable thickness (1 nm, 2 nm, 3 nm, or 4 nm) are dispersed in a carrier at the mass loading factor of about 2.5×10⁶ g/cm². Such preparation is substantially absorbent in the UV range, yet substantially transparent in the visible band.

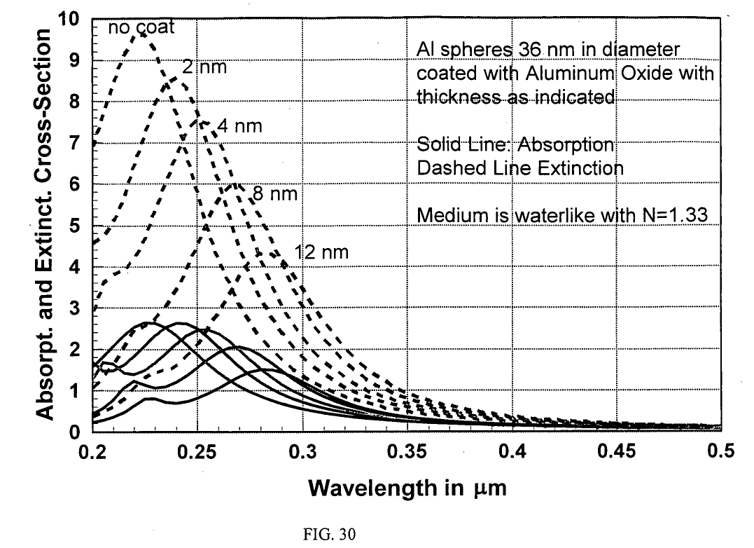

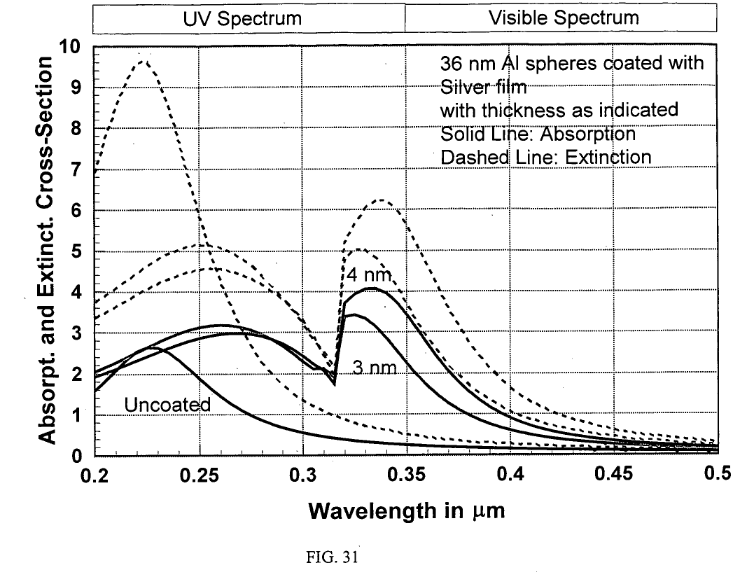

For minimizing visible absorption, the thinner coating of 1 nm to 2 nm are preferred. FIG. 30 shows a particularly simple method of tailoring UV absorption by oxidizing Al nanoparticle core.

This embodiment of the particles of the present invention can be used to block radiation in ultraviolet (UV) spectral band, defined herein as the radiation with the wavelengths between about 200 nm and about 400 nm, while substantially transmitting radiation in the visible band (VIS), defined herein as the radiation with the wavelengths between about 400 nm and about 700 nm. As a non-limiting example, particles of the present invention can be dispersed in an otherwise clear carrier such as glass, polyethylene or polypropylene. The resulting radiation-absorbing material will absorb UV radiation while retaining good transparency in the visible region. A container manufactured from such radiation-absorbing material may be used, for example, for storage of UV-sensitive materials, compounds or food products. Alternatively, a film manufactured from a radiation-absorbing material can be used as coating.

Suitable carriers for the particles of the present invention include, among others, polyethylene, polypropylene, polymethylmethacrylate, polystyrene, polyethylene terephthalate (PET) and copolymers thereof as well as various glasses.

A film or a gel, comprising ink or paints described above, are contemplated by the present invention.

The particles of the present invention can be further embedded in beads in order to ensure a minimal distance between the particles. Preferably, beads are embedded individually in transparent spherical plastic or glass beads. Beads, containing individual particles can then be dispersed in a suitable carrier material.

The particles of the present invention can also be used as highly effective UV filters. Conventional filters often suffer from “soft shoulder” spectral absorption, whereby a rather significant proportion of unwanted frequency bands is absorbed along with the desirable band. The particles of the present invention, by virtue of the resonant absorption, provide a superior mechanism for achieving selective absorption. The color filters can be manufactured by dispersing the particles of the present invention in a suitable carrier, such as glass or plastic, or by coating a desired material with film, comprising the particles of the present invention.

The present invention can furthermore be utilized to produce lotions that protect human skin against harmful UV radiation. In this case, the particles are uniformly dispersed within a pharmacologically safe viscous carrier medium, numerous examples of which are readily available and well known in the cosmetics and pharmaceutical arts. For example, as noted above, particles with metallic cores and shells satisfactorily block UV radiation in the UVA, UVB and UVC spectral regions while transmitting light of longer, i.e. visible, wavelengths; such particles also exhibit little scatter when small enough, thereby avoiding an objectionable milky appearance. A gel or a lotion can be manufactured, for example, comprising the particles of the present invention.

The present invention can also be utilized to produce UV radiation-absorbing wound dressing. The particles or a carrier, in which the particles are dispersed, can be incorporated in or deposed as a coating on a textile, textile-like, or a foam matrix, such as gauze, rayon, polyester, polyurethane, polyolefin, cellulose and its derivatives, cotton, orlon, nylon, hydrogel polymeric materials, or any suitable pharmacologically safe material. Such material can be used as a layer in multi-layer wound dressing or as an absorbent layer attached to a self-adherent elastomeric bandage.

Combining particles of different types within the same carrier material is also contemplated by the instant invention.

Cores and shells comprising metals and conducting materials, such as Al, Ag, Mg, TiN, HfN, and ZrN, as well as high-refracting index materials can be used to produce particles absorbing in UV band. Radiation-absorbing properties of the particles can be adjusted by independently selecting the material, radius and thickness of the core and the shell.

The UV-absorbing particles of the present invention can be prepared by the same methods as described above with reference to FIGS. 20-22.

While this invention has been particularly shown and described with references to preferred embodiments thereof, it will be understood by those skilled in the art that various changes in form and details may be made therein without departing from the scope of the invention encompassed by the appended claims.

1. An electromagnetic radiation-absorbing particle comprising:
(a) a conductive core; and
(b) a dielectric shell encapsulating the conductive core, wherein the size of the core, the material of the core, the thickness of the shell and the material of the shell are such that the particle exhibits a peak of absorption in a predetermined range of wavelengths,
and wherein the particle has a diameter from about 0.1 nm to about 100 nm.

2. The particle of claim 1, wherein the shell is substantially continuous.

3. The particle of claim 1 wherein the particle is substantially spherical.

4. (canceled)

5. The particle of claim 1 wherein the material of the core is selected from a group consisting of Ag, Al, Mg, Cu, Ni, Cr, TiN, ZrN, and HfN.

6. The particle of claim 1, wherein the material of the shell is selected from the group consisting of Si, SiO₂, ZrO₂ TiO₂ and Al₂O₃.

7. The particle of claim 1 wherein the materials of the core and the shell are selected so that the particle exhibits a peak of absorption in a range of wavelengths from about 200 nm to about 700 nm.

8. A method of manufacturing a particle that absorbs electromagnetic radiation in a predetermined range, comprising the step of encapsulating a core with a shell,
wherein the core comprises a conductive material and the shell comprises a dielectric material wherein the size of the core, the material of the core, the thickness of the shell and the material of the shell such that the particle exhibits a peak of absorption in a predetermined range of wavelengths,
and wherein the particle has a diameter from about 0.1 nm to about 100 nm.

9. The method of claim 8, wherein the shell is substantially continuous.

10. The method of claim 8 wherein the particle is substantially spherical.

11. (canceled)

12. The method of claim 8 wherein the material of the core is selected from a group consisting of Ag, Al, Mg, Cu, Ni, Cr, TiN, ZrN, and HfN.

13. The method of claim 8 wherein the material of the shell is selected from the group consisting of Si, SiO₂, ZrO₂ TiO₂ and Al₂O₃.

14. The method of claim 8 wherein the materials of the core and the shell are selected so that the particle exhibits a peak of absorption in a range of wavelengths from about 200 nm to about 700 nm.

15. An electromagnetic radiation-absorptive material for substantially blocking passage of a predetermined range of radiation, comprising a carrier material, and a particulate material dispersed in the carrier material, wherein the particulate material comprises primary particles, said primary particles comprising:
(a) a conductive core; and
(b) a dielectric shell encapsulating the conductive core, wherein the size of the core, the material of the core, the thickness of the shell and the material of the shell are such that the particle exhibits a peak of absorption in a predetermined range of wavelengths,
and wherein the particle has a diameter from about 0.1 nm to about 100 nm.

16. The material of claim 15 wherein the carrier is selected from the group consisting of glass, polyethylene, polypropylene, polymethylmethacrylate, polystyrene, and copolymers thereof.

17. The material of claim 15 further comprising one or more distinct particulate materials.

18. The material of claim 15 wherein the material is selected from the group consisting of ink, paint, lotion, gel, film and solid.

19. The material of claim 15 wherein the primary particles are further embedded in beads.

20. The material of claim 15 wherein the carrier material is a textile, textile-like, or a foam matrix selected from a group consisting of gauze, rayon, polyester, polyurethane, polyolefin, cellulose and its derivatives, cotton, acrylic copolymers (Orlon®), polyamides (Nylon®), and hydrogel polymeric materials.

21. The material of claim 20 wherein the material is attached to a self-adhering elastomeric bandage.

22. The particle of claim 1, wherein the particle has a diameter from about 22 nm to about 80 nm.

23. The method of claim 8, wherein the particle has a diameter from about 22 nm to about 80 nm.

24. The material of claim 15, wherein the particle has a diameter from about 22 nm to about 80 nm.
